(19) United States
(12) Patent Application Publication
(10) Pub. No.: US 2025/0153186 A1
(43) Pub. Date: May 15, 2025

(54) APPARATUS AND METHODS FOR REDUCING AND DESTROYING ELECTRONIC DEVICES

(71) Applicant: Schutte-Buffalo Hammermill, LLC, Buffalo, NY (US)

(72) Inventors: Christopher Berardi, Buffalo, NY (US); Joshua Spalding, Sarasota, FL (US)

(73) Assignee: Schutte-Buffalo Hammermill, LLC, Buffalo, NY (US)

(21) Appl. No.: 18/943,220

(22) Filed: Nov. 11, 2024

Related U.S. Application Data
(60) Provisional application No. 63/597,816, filed on Nov. 10, 2023.

(51) Int. Cl. B02C 21/00; B02C 23/14

(52) U.S. Cl. CPC B02C 21/00; B02C 23/14

(57) ABSTRACT

Disclosed herein is an apparatus for destroying electronic devices including a shredder assembly, a first hammermill assembly, and a second hammermill assembly. The shredder assembly is operatively connected to the first hammermill assembly and the first hammermill assembly is operatively connected to the second hammermill assembly. The shredding assembly, the first hammermill assembly and the second hammermill assembly are configured to destroy electronic devices.

### CLAIM OF PRIORITY

This application claims priority to Provisional Patent Application Ser. No. 63/597,816 filed on Nov. 10, 2023, the entirety of which is hereby incorporated by reference.

### BACKGROUND OF THE DISCLOSURE

The present disclosure relates to devices and methods for an apparatus designed to reduce and destroy electronic devices.

Destruction of electronic devices is a common practice in their disposal. Electronic devices may include storage devices such as hard drives. Destruction of storage devices may be subject to regulatory requirements or business security measures. Destruction of storage devices may be necessary in order to protect communications and business records. As such, an effective means for destroying electronic devices beyond recovery is desirable.

Thus, there is a need for an apparatus for reducing and destroying electronic devices that overcomes deficiencies in existing devices while providing better overall results.

### BRIEF DESCRIPTION OF THE DISCLOSURE

Disclosed in various embodiments are electronic device destroying apparatuses utilizing a shredder assembly and two hammermill assemblies.

In some embodiments the electronic device destroying apparatus may include chutes to move electronic device pieces throughout the apparatus.

In other embodiments the electronic device destroying apparatus may include a plurality of screens to ensure that the electronic device pieces are sufficiently reduced in size.

In accordance with one aspect of the disclosure, an apparatus for destroying electronic device includes a shredder assembly, a first hammermill assembly, and a second hammermill assembly; wherein the shredder assembly is operatively connected to the first hammermill assembly and the first hammermill assembly is operatively connected to said second hammermill assembly. The shredding assembly, the first hammermill assembly and the second hammermill assembly are configured to destroy electronic devices.

In accordance with another aspect of the disclosure, a method of reducing and destroying electronic devices includes the steps of: inserting an electronic device into a shredder, resulting in a plurality of shredder remnants; transferring the plurality of shredder remnants into a first hammermill, resulting in a plurality of first hammermill remnants; transferring the first hammermill remnants into a second hammermill, resulting in a plurality of second hammermill remnants.

In accordance with another aspect of the disclosure, a method of gradually reducing the size of electronic components includes the steps of: placing a plurality of electronic components into a first component size reduction apparatus, resulting in a plurality of first component size reduction apparatus remnants; transferring the plurality of first component size reduction apparatus remnants to a second component size reduction apparatus, resulting in a plurality of second component size reduction apparatus remnants; transferring the plurality of second component size reduction apparatus remnants to a third component size reduction apparatus, resulting in a plurality of third component size reduction apparatus remnants.

Still other aspects of the present disclosure will be apparent upon a reading and understanding of the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front left perspective view of the electronic device destroying apparatus.

FIG. 2 is a front right perspective view of the electronic device destroying apparatus with the shredder removed.

FIG. 3 is a front right perspective view of the electronic device destroying apparatus with various parts removed and open.

FIG. 4 is a front right perspective view of the electronic device destroying apparatus with various parts removed to show the chutes.

### DETAILED DESCRIPTION OF THE DISCLOSURE

A more complete understanding of the components and devices disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The terms “top” or “upper” and “bottom” or “lower” are used to refer to locations/surfaces where the top/upper is always higher than the bottom/lower relative to an absolute reference, i.e. the surface of the earth. The terms “upwards” and “downwards” are also relative to an absolute reference; upwards is always against the gravity of the earth.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other.

The present disclosure relates to a device and methods for reducing and destroying electronic devices.

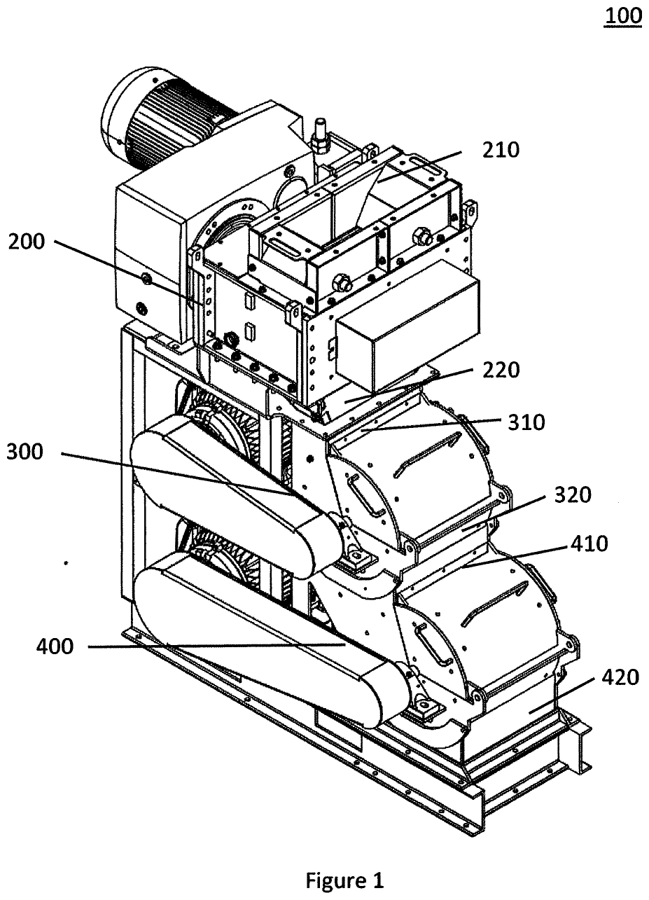

In particular, FIG. 1 is a front left side perspective view of the electronic device destroying apparatus 100 in accordance with a preferred embodiment of the disclosure. The shredder assembly 200 can be seen with shredder assembly input end 210 and shredder assembly output end 220. The shredder assembly output end 220 leads to the first hammermill assembly 300. The first hammermill assembly input end 310 of the first hammermill 300 can be seen adjacent to the shredder assembly output end 220. The first hammermill assembly output end 320 can also be seen adjacent to the second hammermill assembly input end 410 of the second hammermill assembly 400. The second hammermill assembly output end 420 may also be seen at the bottom of the second hammermill assembly 400.

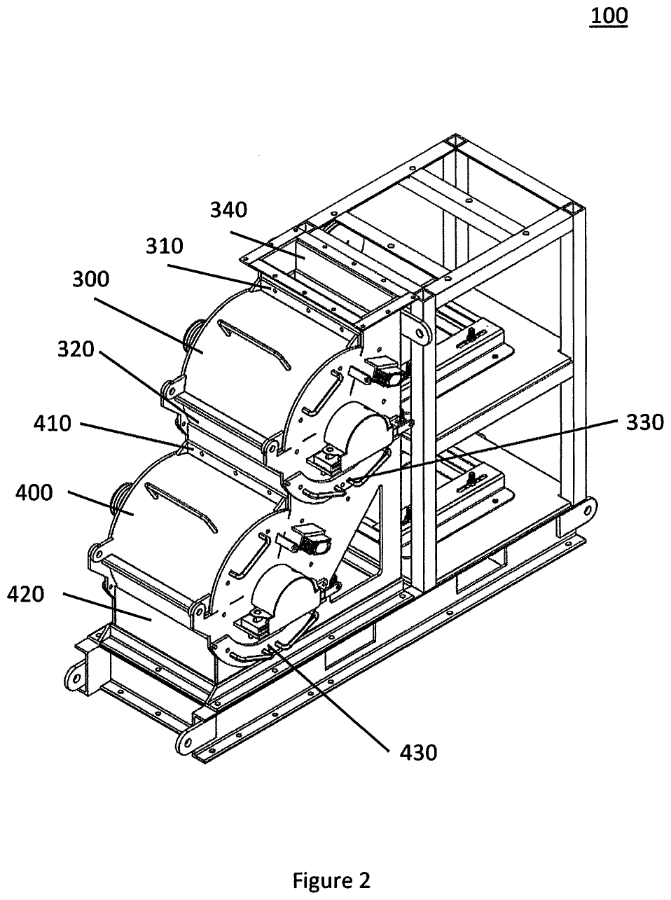

FIG. 2 is a front right side perspective view of the electronic device destroying apparatus 100 with the shredder assembly 200 removed. The removal of the shredder assembly 200 allows the first chute 340 to be seen near the first hammermill assembly input end 310. The first hammermill assembly 300 can again be seen with the first hammermill assembly output end 320. A first screen 330 can be seen between the first hammermill assembly output end 320 and the second hammermill assembly input end 410. The second hammermill assembly 400 can also be seen with the second hammermill assembly output end 420 and a second screen 430.

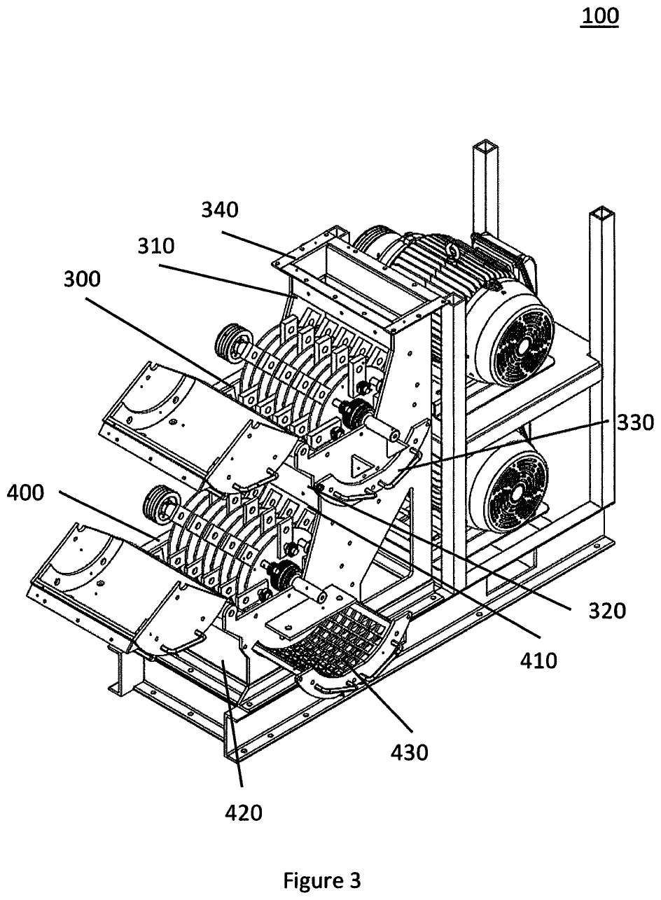

FIG. 3 is a front right side perspective view of the apparatus 100 with various components removed and showing inside of the first hammermill assembly 300 and second hammermill assembly 400. The first chute 340 can be seen near the first hammermill assembly input end 310. The first screen 330 can be seen between the first hammermill assembly output end 320 and the second hammermill assembly input end 410. The second screen 430 can also be seen partially in place near the second hammermill assembly output end 420.

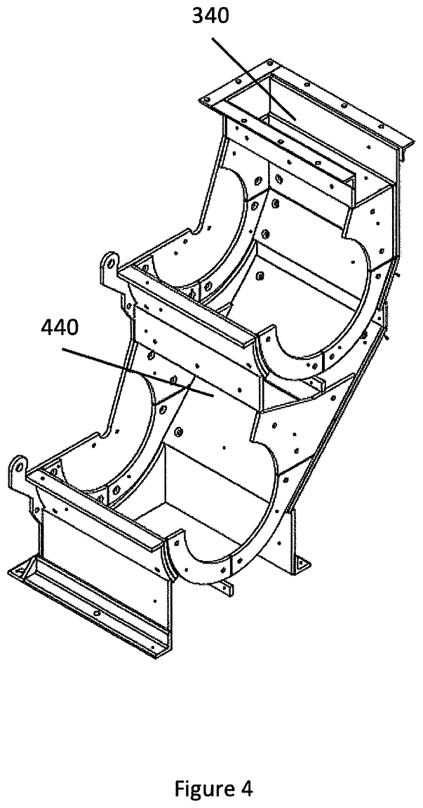

FIG. 4 is a front right side perspective view of the apparatus 100 with a majority of its components removed in order to show the first chute 340 and second chute 440.

Referring to all figures together it can be seen that the shredder assembly 200 is generally above the first hammermill assembly 300 which is generally above the second hammermill assembly 400. This layout allows for gravity to help an electronic device placed in the shredder assembly input end 210 to move through the electronic device destroying apparatus 100 and pass through first screen 330 and eventually pass through second screen 430 that is placed after the second hammermill assembly output end 420.

In some embodiments an electronic device may be placed in the shredder assembly input end 210 and then is shredded by the shredder assembly 200. The pieces of the electronic device would then come out of the shredder assembly output end 220 and move into the first hammermill assembly input end 310.

In certain embodiments the electronic component pieces may be moved from the shredder assembly output end 220 to the first hammermill assembly input end 310 through the use of a first chute 340; while in other embodiments the geometry of the shredder assembly 200 and the first hammermill assembly 300 may allow the pieces to fall directly from the shredder assembly output end 220 to the first hammermill assembly input end 310.

Once the pieces enter the first hammermill assembly input end 310 they are then reduced in size by the first hammermill assembly 300. The reduced size electronic device pieces then move out of the first hammermill assembly output end 320 and through a first screen 330 and into the second hammermill assembly input end 410.

In certain embodiments the moving of the reduced size electronic device pieces from the first hammermill assembly output end 320 to the second hammermill assembly input end 410 may be facilitated by the use of a second chute 440; while in other embodiments the geometry off the first hammermill assembly 300 and the second hammermill assembly 400 may allow the reduced size electronic device pieces to fall directly from the first hammermill assembly output end 320 to the second hammermill assembly input end 410.

Once the reduced size electronic device pieces enter the second hammermill assembly input end 410 they are again reduced in size by the second hammermill assembly 400 and move out of the second hammermill assembly output end 420 and through second screen 430.

Methods of destroying electronic devices using the electronic device destroying apparatus 100 are also disclosed. Such methods may include the use of any of the various embodiments of electronic device destroying apparatuses disclosed herein. The methods include placing an electronic device in the shredder 200 and resulting in electronic device pieces, then the electronic device pieces may be placed in the first hammermill assembly 300, and then the pieces may be transferred to the second hammermill assembly 400. While in the first hammermill assembly 300 the size of the electronic device pieces is generally reduced. In some embodiments the electronic device pieces may have to pass through a first screen 330 to move to the second hammermill assembly 400. In the second hammermill assembly 400 the electronic device pieces are again reduced in size. In some embodiments the electronic device pieces may have to pass through a second screen 430 in order to exit the electronic device destroying apparatus 100.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. An apparatus for destroying electronic devices comprising:
a shredder assembly,
a first hammermill assembly,
and a second hammermill assembly; wherein said shredder assembly is operatively connected to said first hammermill assembly and said first hammermill assembly is operatively connected to said second hammermill assembly;
wherein said shredding assembly, said first hammermill assembly and said second hammermill assembly are configured to destroy electronic devices.

2. The apparatus of claim 1, wherein the shredder assembly has a shredder input end and a shredder output end, the first hammermill assembly has a first hammermill input end and a first hammermill output end, and the second hammermill assembly has a second hammermill input end and a second hammermill output end.

3. The apparatus of claim 2, wherein the shredder output end is operatively connected to the first hammermill input end and the first hammermill output end is operatively connected to the second hammermill output end.

4. The apparatus of claim 2, further comprising a plurality of chutes.

5. The apparatus of claim 2, further comprising:
a first chute, the first chute connecting the shredder output end and the first hammermill input end;
a second chute, the second chute connecting the first hammermill output end and the second hammermill input end.

6. The apparatus of claim 1, wherein the first hammermill assembly is a single rotor hammermill.

7. The apparatus of claim 1, wherein the second hammermill assembly is a single rotor hammermill.

8. The apparatus of claim 1, further comprising a plurality of screens.

9. The apparatus of claim 2, further comprising:
a first screen, the first screen located between the first hammermill output end and the second hammermill input end;
a second screen, the second screen located after the second hammermill output end.

10. The apparatus of claim 9, wherein the second screen is less permissive than the first screen.

11. A method of destroying electronic devices, the method comprising the steps of:
inserting an electronic device into a shredder, resulting in a plurality of shredder remnants;
transferring the plurality of shredder remnants into a first hammermill, resulting in a plurality of first hammermill remnants;
transferring the first hammermill remnants into a second hammermill, resulting in a plurality of second hammermill remnants.

12. The method of claim 11, wherein the transferring of the plurality of shredder remnants into the first hammermill is facilitated by gravity.

13. The method of claim 12, wherein the transferring of the plurality of shredder remnants is assisted by the use of a chute.

14. The method of claim 11, wherein the transferring of the plurality of first hammermill remnants into the second hammermill is facilitated by gravity.

15. The method of claim 14, wherein the transferring of the plurality of first hammermill remnants is assisted by the use of a chute.

16. The method of claim 11, further comprising the step of running the plurality of first hammermill remnants must through a screen before being transferred to the second hammermill.

17. The method of claim 11, further comprising the step of running the plurality of second hammermill remnants through a screen, resulting in a plurality of finished remnants.

18. The method of claim 11, further comprising the steps of:
running the plurality of first hammermill remnants through a screen before being transferred to the second hammermill;
running the plurality of second hammermill remnants through a screen, resulting in a plurality of finished remnants;
wherein, the screen used for the plurality of second hammermill remnants is less permissible than the screen used for the plurality of first hammermill remnants.

19. A method of gradually reducing the size of electronic components comprising the steps of:
placing a plurality of electronic components into a first component size reduction apparatus, resulting in a plurality of first component size reduction apparatus remnants;
transferring the plurality of first component size reduction apparatus remnants to a second component size reduction apparatus, resulting in a plurality of second component size reduction apparatus remnants;
transferring the plurality of second component size reduction apparatus remnants to a third component size reduction apparatus, resulting in a plurality of third component size reduction apparatus remnants.
